(19) United States
(12) Patent Application Publication
(10) Pub. No.: US 2002/0179535 A1
(43) Pub. Date: Dec. 5, 2002

(54) Filter assembly for sprayers

(76) Inventor: George Lutich, Palm Harbor, FL (US)

Correspondence Address: JOSEPH A MAHONEY, MAYER BROWN & PLATT, PO BOX 2828, CHICAGO, IL, 60690-2828, US

(21) Appl. No.: 09/781,865

(22) Filed: Feb. 12, 2001

Related U.S. Application Data
(63) Continuation-in-part of application No. 09/766,031, filed on Jan. 19, 2001.
(63) Continuation-in-part of application No. 09/736,637, filed on Dec. 14, 2000.
(63) Continuation-in-part of application No. 09/431,942, filed on Oct. 1, 1999, now abandoned.
(60) Provisional application No. 60/249,033, filed on Nov. 15, 2000.

(51) Int. Cl. C02F 1/42

(52) U.S. Cl. 210/688; 210/266

(57) ABSTRACT

An improved filter device for the removal of contaminants from water and method of using same. Disclosed is a filter assembly for a spray attachment that is easily replaced and either concealed or partially concealed.

### RELATED APPLICATION

This application is based on and claims priority to U.S. Patent Provisional Application Serial No. 60/249,033, filed Dec. 7, 2000, and is a continuation-in-part of U.S. patent application Ser. No. 09/766,031, filed Jan. 19, 2001, and of U.S. patent application Ser. No. 09/736,637, filed Dec. 14, 2000, which is a continuation-in-part of U.S. patent application Ser. No. 09/431,942 filed Oct. 1, 1999, the disclosures of which are incorporated by reference herein to the extent permitted by law.

### FIELD OF THE INVENTION

The present invention relates to fluid treatment. In particular, the present invention relates to water filtration devices for sink spray attachments.

### BACKGROUND OF THE INVENTION

Tap water contains many contaminants. If not removed from the water, these contaminants may present health risks, may damage plumbing and personal property, and may adversely affect the taste of water. The principal contaminants naturally occurring in water are iron, sulfur, manganese, lead, and cryptosporidium cysts. Many man-made contaminants are also now found in tap water. These man-made contaminants may be introduced into the water supply as part of or as by-products of herbicides, pesticides, fertilizers and the like placed on and into the ground. These contaminants are believed to be carcinogenic and may present serious long term health risks to users of this contaminated water.

Traditionally, water filters have been placed under the main faucet spout, thereby filtering the water after it has traveled through the main faucet. Water filters of the prior art have been attached to sink faucets by various mechanisms. Typically, filters are mounted onto the threads of a faucet diverter section or have hoses attached thereto. The filter cartridge protrudes sideways or upwards from the diverter section into the upper work area of the sink or are placed behind the faucet. The placement of the filter in these positions is cumbersome for a user cleaning dishes or performing routine hygienic functions. Further, the placement of the filter outward and upward from the faucet is in plain view and unsightly to the user. Providing filtered water outside of the sink area is also difficult to accomplish with filters that are placed on the main faucet. Therefore, a concealed or partially concealed water filter for a spray attachment is desirable to provide filtered water outside of the sink area.

Several water filters of the prior art have been placed in a faucet spray wand assembly. However, the filters of the prior art are placed in the main faucet spout and require cumbersome dismantling of the spray wand to replace the used cartridge.

### SUMMARY OF THE INVENTION

The foregoing problems are solved and a technical advance is achieved by the present invention. Disclosed is a filter assembly for a spray attachment that is easily replaceable.

### BRIEF DESCRIPTION OF THE DRAWINGS

FIG. 1 is a cross-sectional view of a standard spray attachment of the prior art.

FIG. 2 is a cross-sectional view of one embodiment of a spray head utilized in the present invention.

FIG. 3A is a cross-sectional view of an embodiment of the filter assembly of the present invention.

FIG. 3B is a top planar view of an end cap for the filter assembly of the present invention showing radial ribs that direct the water flow.

FIG. 4 is a cross-sectional view of another embodiment of the filter assembly of the present invention.

FIG. 5 is a cross-sectional view of an embodiment of a spray head of the present invention.

FIG. 6 is a cross-sectional view of another embodiment of the filter assembly of the present invention.

FIG. 7 is a perspective view of a two handle faucet assembly with a spray attachment utilizing a filter assembly of the present invention.

FIG. 8A is a perspective view of a single handle faucet assembly with a spray attachment utilizing another embodiment of the filter assembly of the present invention.

FIG. 8B an enlarged cross-sectional view of an adapter tee of the present invention.

FIG. 9 is a perspective view of a single handle faucet assembly without a spray attachment utilizing another embodiment of the filter assembly of the present invention.

FIG. 10 is a partial cross-sectional view of a spray attachment and filter assembly of the present invention.

FIG. 11A is a cross-sectional view of a spray attachment and filter assembly of the present invention.

FIG. 11B is a partial cross-sectional view of a typical installation of the spray attachment of FIG. 11A.

FIG. 11C is an enlarged cross-sectional view of an embodiment of a fitting utilized in the present invention.

### DETAILED DESCRIPTION

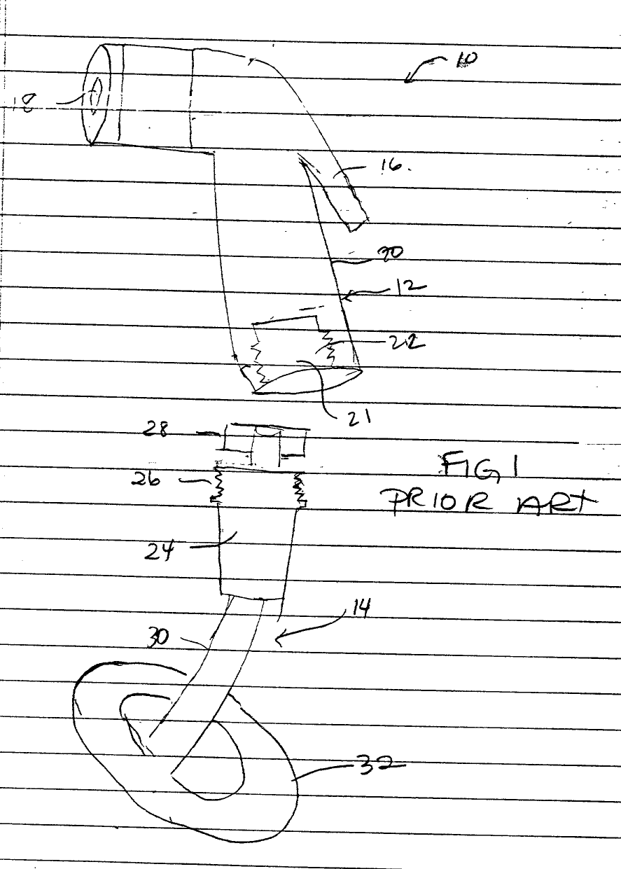

FIG. 1 depicts a spray attachment 10 as is generally known in the art. The spray attachment 10 is standard for most kitchen sinks. The spray attachment 10 comprises a spray head 12 and a spray hose assembly 14. A spray handle 16 extending from a body 20 of the spray head 12 controls the release of water out of a nozzle 18. The spray body 20 also houses other elements necessary for holding and dispensing water from the spray head 12 as are well known in the art including but not limited to valves, channels, seals, and flow restrictors. The body 20 of the spray head 12 detachably attaches to the spray hose assembly 14. The body 20 comprises an opening 21 which receives a spray hose coupling 24 of the spray hose assembly 14. In one embodiment, a female end 22 of the body 20 receives a male end 26 of the spray hose coupling 24 of the spray hose assembly 14. The spray hose coupling 24 detachably attaches the spray head 12 to a spray hose 30 of the spray hose assembly 14 with threads or other coupling mechanisms as are generally known in the art. In one embodiment, the female end 22 having ¼ inch NSP internal threads receives the male end 26 having ¼ inch NSP external threads.

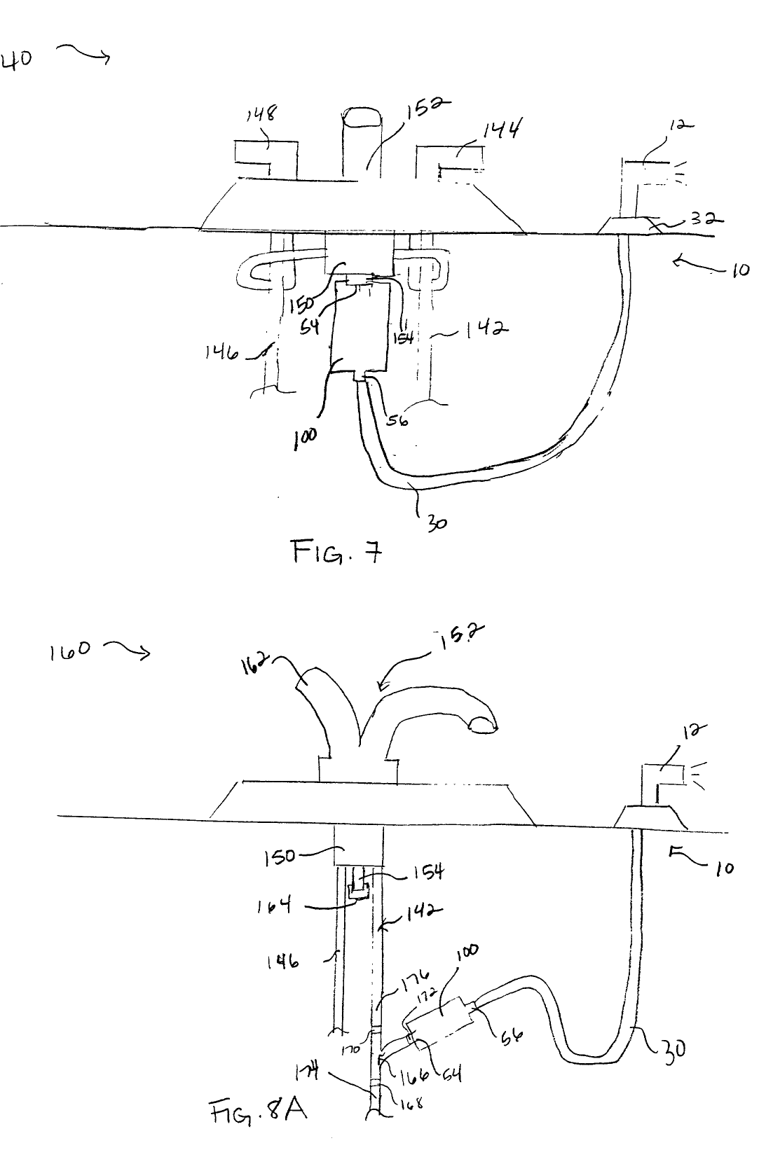

The spray hose 30 provides a water supply that is dispensed through the nozzle 18 of the spray head 12. The spray hose assembly 14 has a seal 28 that prevents water from leaking from the spray hose 30 when the male end 26 of the spray hose assembly 14 is detachably attached to the female end 22 of the spray head 12. The spray attachment 10 may remain in a resting position in a spray holder 32 affixed to a sink 34 (FIG. 7) or may be extended out of the spray holder 32 and hand-held in an extended position for use in areas outside of the sink 34.

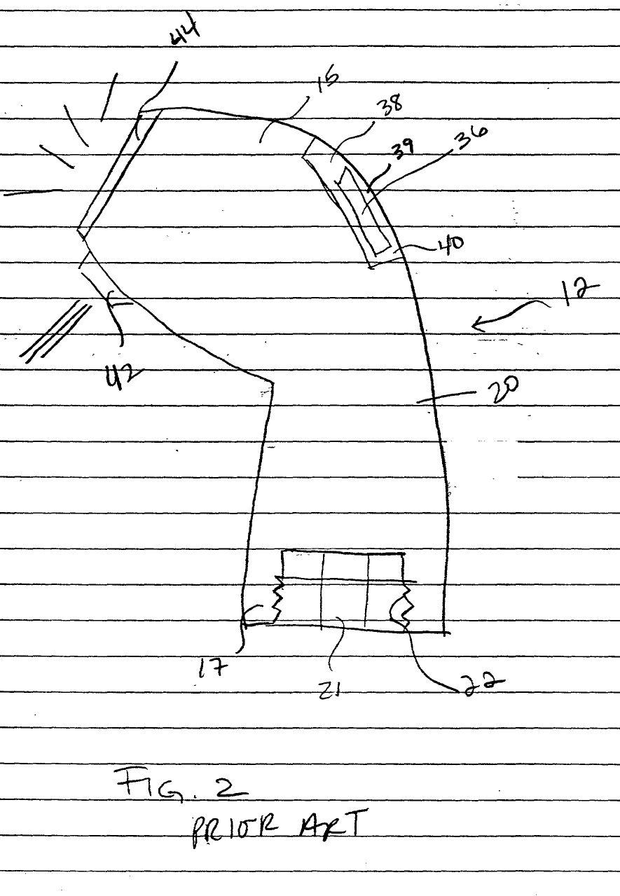

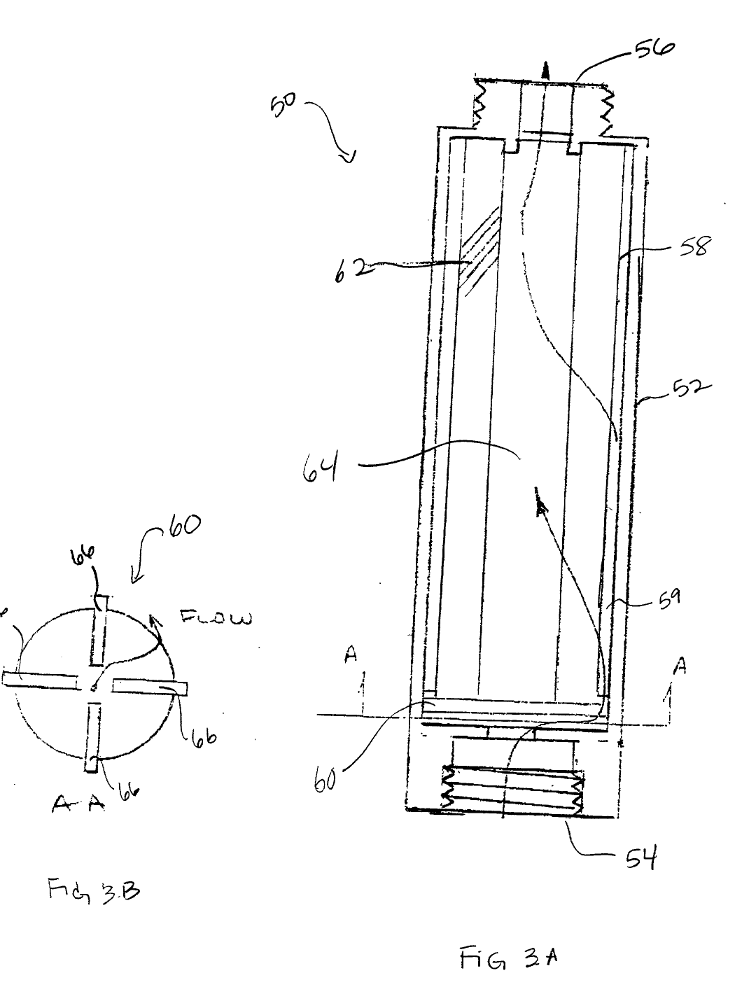

As depicted in FIG. 2, it is known that the spray head 12 may dispense water in a spray or stream pattern. A selector valve 36 on the spray head 12 has a stream position 38, an off position 39, and a spray position 40 which controls the pattern for dispensing water. FIG. 2 depicts the selector valve 36 as a switch which slides into the stream position 38 when a user pushes the selector valve up the spray body 20 and into the spray position 40 when a user pushes the valve down the spray body 20. One skilled in the art would recognize that the stream, off, and spray positions 38, 39, and 40, respectively, may be interchanged, and further may be controlled by other selector mechanisms as are generally known in the art. When the selector valve 36 is in the stream position 38, water dispenses through a stream spout 42 on the spray body 20. When the selector valve 36 is in the spray position 40, water dispenses through a spray spout 44 of the spray body 20. In one embodiment, the water dispensed from the stream spout 42 is directed downwardly toward the sink 34 and the water dispensed from the spray spout 44 is directed away from the sink 34. Therefore, typically, the spray position 40 may be used when the spray attachment 10 is in the extended position so as to direct the spray spout 44 at a desired object. The spray hose assembly 14 may detachably attach to the spray head 12 in the manner described above.

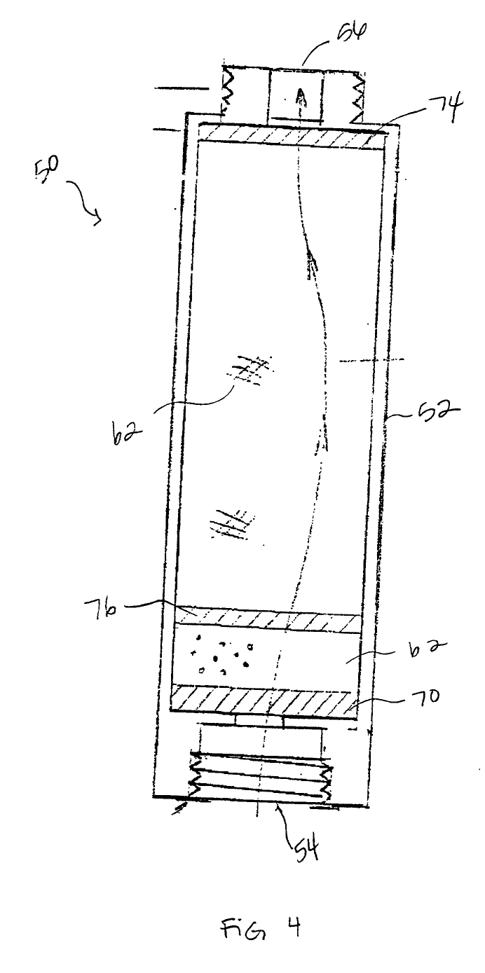

FIGS. 3A and 4 depict a filter assembly 50 for filtering water supplied to the spray attachment 10. The filter assembly 50 reduces the amount of particles and other contaminants in the water supply and improves the taste and odor of the water supply. The filter assembly 50 includes a housing 52 having an inlet 54 and an outlet 56 to allow water to flow through the housing 52. The housing 52 is preferably constructed or injection molded of acrylonitrile-butadiene-styrene (ABS). Those skilled in the art, however, will appreciate that any suitable temperature resistant thermoplastic material or other suitable material may be utilized for the housing 20. In both FIGS. 3A and 4, the inlet 54 of the filter assembly 50 mates with the spray hose coupling 24 of the spray hose assembly 14 (FIG. 1) and the outlet 56 mates with the opening 21 of the spray head 12 (FIG. 1) to provide filtered water to the spray head 12. One skilled in the art would recognize that any filter assembly 50 may be employed in the present invention as long as the inlet 54 and the outlet 56 are configured to mate with spray hose coupling 24 and the opening 21, respectively. In one embodiment of the present invention, the inlet 54 has internal threads and the outlet 56 has external threads which correspond with the male end 26 and female end 22 threads, respectively. In one embodiment, the inlet 54, the outlet 56, 10 the male end 26 and the female end 22 all have ¼ inch NSP threads. The configuration of the inlet 54, the outlet 56, the opening 21, and the spray hose coupling 24 may be reversed so that the inlet 54 has external threads to engage a female end on the spray hose assembly 14 and the outlet 56 has internal threads to engage a male end in the opening 21.

In one embodiment, depicted in FIGS. 3A and 3B, the filter assembly 50 may further comprise a filter cartridge 58, a channel 59, and an end cap 60. As depicted in FIG. 3B, radial ribs 66 on the end cap 60 fix the position of the filter cartridge 58 in the housing 52. The end cap 60 seals the filter assembly 50 at the inlet 54 to prevent flow of the filtered water back into the spray hose 30. The water flows around the radial ribs 66 into the channel 59. The channel 59 fluidly communicates with the inlet 54 and provides a path for the water supply to reach the filter cartridge 58. The filter cartridge 58 comprises a media 62 and an axial void 64 running down the center of the housing 52. The media 62 may include but is not limited to carbon block, copper, far infrared media, KDF, and Activated Titanium Carbon (“ATC”). The media 62 works especially well in sulfated waters where sulfates have been used as sequestering or flocculating agents. Other contaminants in water, like lead and other heavy metals, are removed or reduced as the contaminant is bonded to the media 62. Further, it is believed that oxidation/reduction reactions occurring within the media 62 control microbial growth. Organisms specifically controlled include fungi, algae and bacteria. Once the water supply travels through the media 62 in the cartridge 58, the water exits the filter assembly 50 through the axial void 64 and the outlet 56.

FIG. 4 depicts another embodiment of the filter assembly 50. The filter assembly 50 may include filter pads for preventing the media from traveling outside of the housing. For example, an inlet pad 70 inside the housing 52 prevents the filtering media 62 from through the inlet 54 and an outlet pad 74 prevents the media 62 from traveling through the outlet 56. In one embodiment, various types of filtering media 62 may be employed which may be separated into separate chambers by at least one interior pad 76. The media 62 may include but is not limited to any combination of far infrared, copper, granulated activated carbon, KDF, and ATC. The skilled artisan will appreciate that the interior pad 76 need not be present to accomplish the objective of the present invention. In such an embodiment, the housing 52 is sequentially filled with different types of media 62 such that there are substantially distinct areas of the different media 62, yet they are in contact with each other. The inlet pad 70, the outlet pad 74, and the interior pad 76 may be constructed from any type of porous material including but not limited to stainless steel mesh or screens, Porex, plastic mesh or screens, and sintered metal.

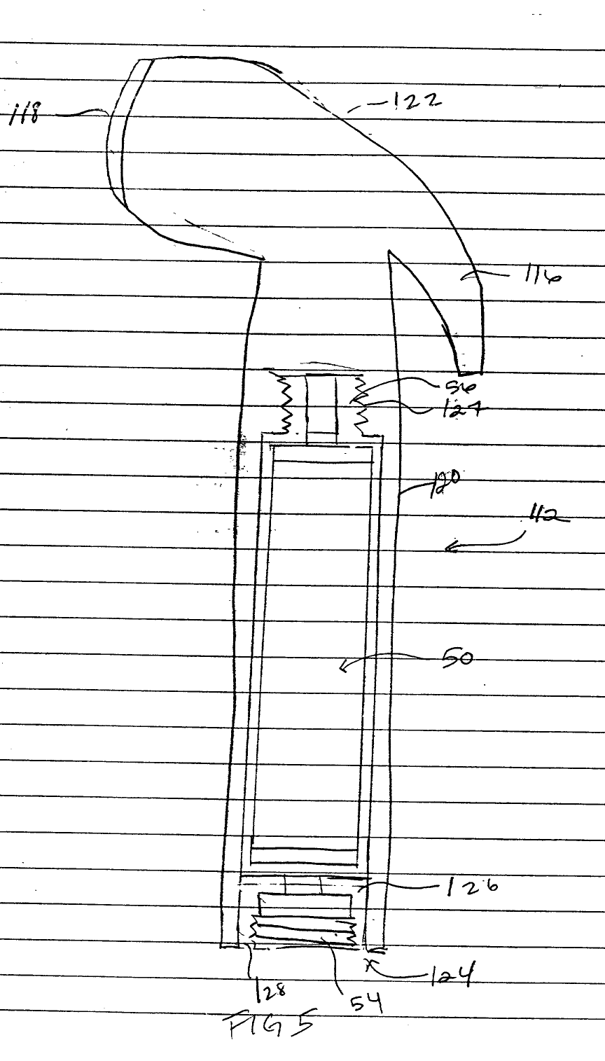

In another embodiment of the present invention depicted in FIG. 5, a filter assembly 50 may be inserted into a spray head 112. The spray head 112 comprises a spray handle 116, a nozzle 118, and a spray body 120. The spray body 120 is elongated in comparison to those generally known in the art to conceal the filter assembly 50 inside the spray head 112. The spray body 120 has a distal end 122 and a proximal end 124 and a cavity 126 extending from the proximal end 124 to at least partially the distal end 122. The distal end 122 comprises the spray handle 116 and the nozzle 118 as well as other water dispensing components (not shown) as are generally known in the art for controlling the flow of water out of the spray head 112. Water dispensing components include but are not limited to valves, channels, seals, and flow restrictors. The cavity 126 houses the filter assembly 50. The proximal end 124 of the spray body 120 has an opening 128 for receiving the filter assembly 50 into the cavity 126. In one embodiment, toward the distal end 122 of the spray body 120, the cavity 126 has a female end 127 to receive the outlet 56 of the filter assembly 50. The female end 127 has internal threads that receive the external threads of the outlet 56. When the outlet 56 engages the female end 127 of the cavity 126, the filter assembly 50 is detachably attached to the spray head 112. The spray hose assembly 14 described above may be employed to fluidly communicate with the proximal end 124 of the spray body 120 and the inlet 54 of the filter assembly 50. The spray hose coupling 24 detachably attaches to the inlet 54 as described above.

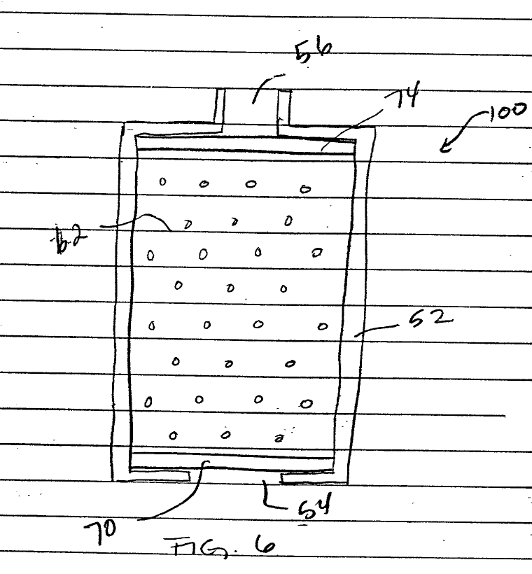

The filter assembly 50 may serve as the primary and only filter or may be secondary to or replaced by a filter assembly 100. FIGS. 6-9 depict a filter assembly 100 for filtering water supplied to a spray attachment 10, which may be concealed under a sink 34.

As depicted in FIG. 6, the filter assembly 100 comprises a housing 52 having the inlet 54 and the outlet 56 to allow water to flow through the housing 52 and the outlet pad 74 impeding the filtering media 62 from traveling through the outlet 56. In one embodiment, various types of filtering media 62 may be employed, which may be separated into separate chambers (not shown) by interior pads 76 (not shown). The skilled artisan will appreciate that the interior pad 76 need not be present to accomplish the objective of the present invention. In such an embodiment, the housing 52 is sequentially filled with different types of media 62 such that there are substantially distinct areas of the different media 62, yet they are in contact with each other. In another embodiment, the inlet pad 70 impedes the movement the filtering media 62 through the inlet 54. The same materials may be used for the media 62 and the housing 52 as well as the outlet pad 74, the inlet pad 70, and the interior pads 76 as described above. Further, the inlet pad 70, the outlet pad 74, and the interior pads 76 may have a mesh value in a range of about 50 to about 100 microns.

The foregoing description exemplifies a simple embodiment of the filter assembly 100. One skilled in the art would recognize that many types of filter assemblies may be employed in the present invention. In the following embodiments, the filter assembly 100 may be concealed under the sink 34 and within a cabinet (not shown). In one embodiment, the filter assembly 100 is affixed to the cabinet.

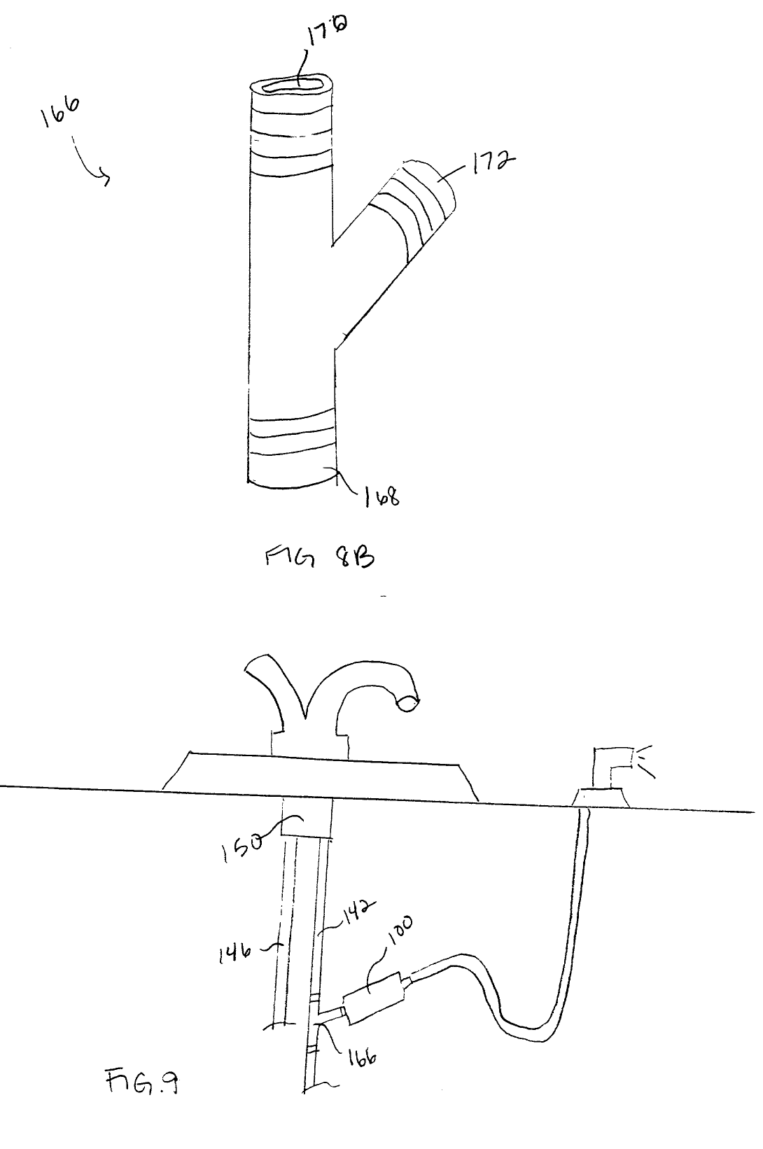

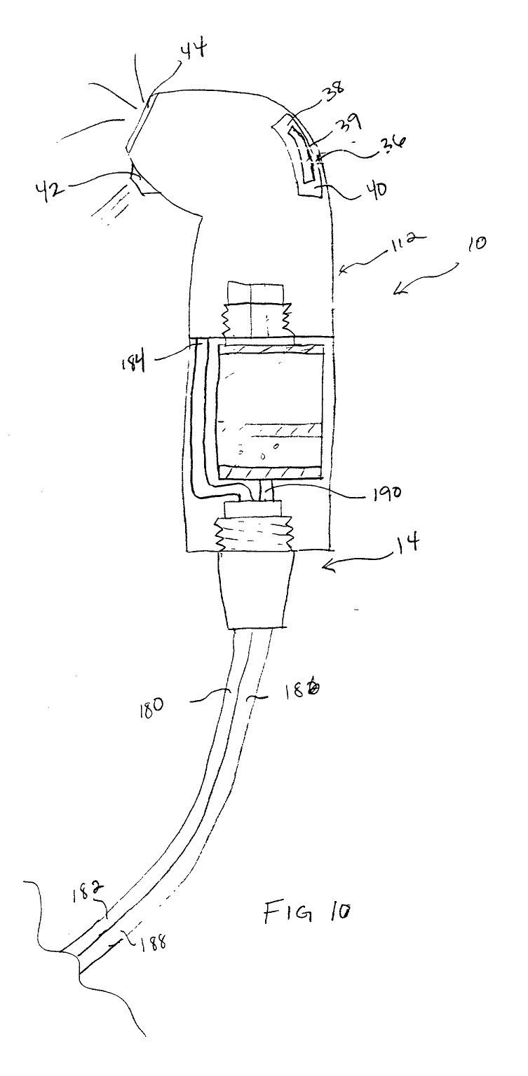

The filter assembly 100 may be utilized with a two-handle faucet assembly 140 as depicted in FIG. 7 or with a single handle faucet assembly 160 as depicted in FIG. 8A and 9. Also, the filter assembly 100 may be used with faucet assemblies having the spray attachment 10 as depicted in FIGS. 7 and 8A or with faucet assemblies without the spray attachment 10 as depicted in FIG. 9. The following embodiments describe the filter assembly 100 in relation to either the single handle or the two-handle faucet assembly 160 and 140, respectively, and in relation to faucet assemblies with or without the spray attachment 10. These embodiments are not intended to be limited to the particular faucet assemblies depicted. One skilled in the art would recognize that these embodiments may be carried out by employing any of the faucet assemblies described.

In the two-handle faucet assembly 140 depicted in FIG. 7, a cold water supply line 142 runs to a cold water handle 144 and a hot water supply line 146 runs to a hot water handle 148. The cold water supply line 142 and the hot water supply line 146 combine each water supply at a coupler tee 150 with standard plumbing fittings (not shown) including but not limited to washers, nuts, and rings, as are generally known in the art. O-rings (not shown) provide a water tight seal between the other fittings connecting the supply lines 142 and 146 and the coupler tee 150 to permit water flow therethrough without leakage. The cold and hot water supply lines 142 and 146, respectively, may be made of a copper material, or other similarly conductive material, which may connect to a flexible hose material from the cold and hot water handles 144 and 148, respectively, to the coupler tee 150. The coupler tee 150 then fluidly communicates with a spout assembly 152. One skilled in the art would recognize that a spout assembly 152 may include but is not limited to spouts, rings, seals, and diverters (not shown). A hose shank 154 also extends from the coupler tee 150 to provide fluid communication between the coupler tee 150 and the spray hose 30. The spray hose 30 connects to the hose shank 154 and provides the water supply to the spray head 12. However, in this embodiment, the spray hose 30 is disconnected from the hose shank 154. Instead, the inlet 54 of the filter assembly 100 may be detachably attached to the hose shank 154 with the fittings (not shown). The outlet 56 of the filter assembly 100 detachably attaches to the spray hose 30 with fittings that are well known in the art. The spray hose 30 detachably attaches to the spray head 12 or spray head 112 as described above. The spray hose 30 is stored under the sink 34 and is supplied through the spray holder 32 when the spray hose 30 is pulled. In one embodiment, approximately 48 inches of spray hose 30 is utilized.

Alternatively, the filter assembly 100 may be plumbed directly into the cold water supply line 142 as depicted in FIG. 8A. FIG. 8A depicts a single handle faucet assembly 160 with a cold water supply line 142 and a hot water supply line 146 that combine each water supply at the coupler tee 150 with the fittings (not shown) described above. The cold and hot water supply lines 142 and 146, respectively, may be made of a copper material, or other similarly conductive material. The coupler tee 150 fluidly communicates with the spout assembly 152. A handle 162 extends from the spout assembly 152 to control the temperature and amount of water dispensed from the spout assembly 152. One skilled in the art would recognize that a spout assembly 152 may include but is not limited to spouts, rings, seals, and diverters (not shown). A hose shank 154 may also extend from the coupler tee 150 to provide fluid communication with the spray attachment 10. However, in this embodiment, the spray hose 30 is removed from the hose shank 154, and the hose shank 154 is covered with a pipe cap 164. The filter assembly 100 is plumbed into the cold water supply line 142 with an adapter tee 166 having ports 168, 170, and 172, as depicted in FIG. 8B. Port 168 of the adapter tee 166 receives the lower portion 174 of the cold water supply line 142. Port 170 receives the upper portion 176 of the cold water supply line 142 which carries the cold water supply to the coupler tee 150. Port 172 receives the inlet 54 of the filter assembly 100. The outlet 56 of the filter assembly 100 may have a fitting (not shown) that attaches to the spray hose 30 that supplies filtered water to the spray head 12.

FIG. 9 depicts an embodiment of a faucet assembly which is not configured to receive the spray attachment 10. The filter assembly 100 connects to the cold water supply line 142 in the same manner as described for FIG. 8A, except that the pipe cap 164 is not needed because the coupler tee 150 does not have a hose shank 154.

The foregoing embodiments have been described in relation to providing a filtered cold water supply to the spray attachment 10. One skilled in the art would recognize that a filtered hot water supply could be provided to the spray attachment 10 in a similar manner.

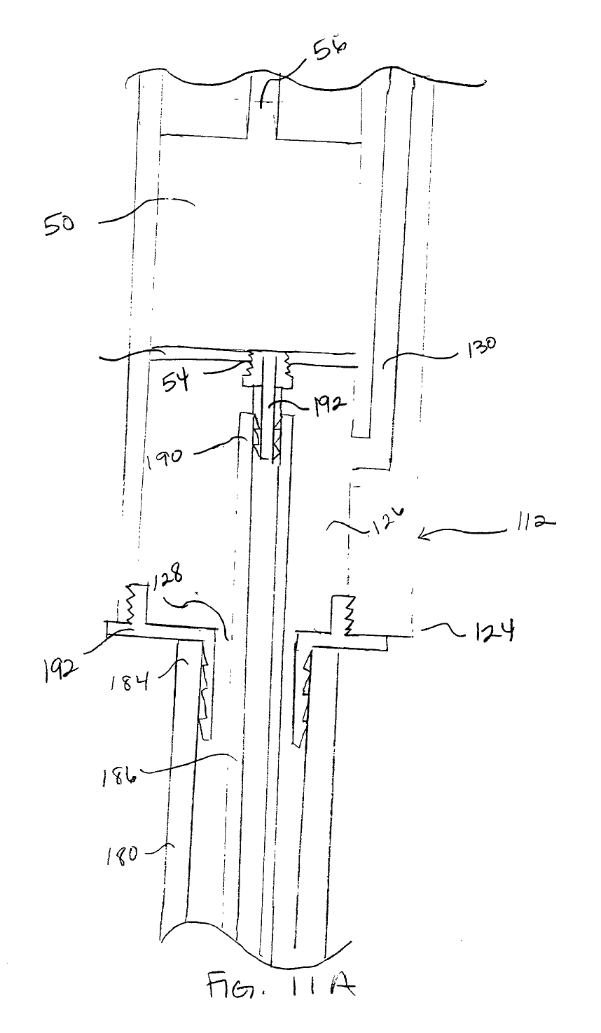

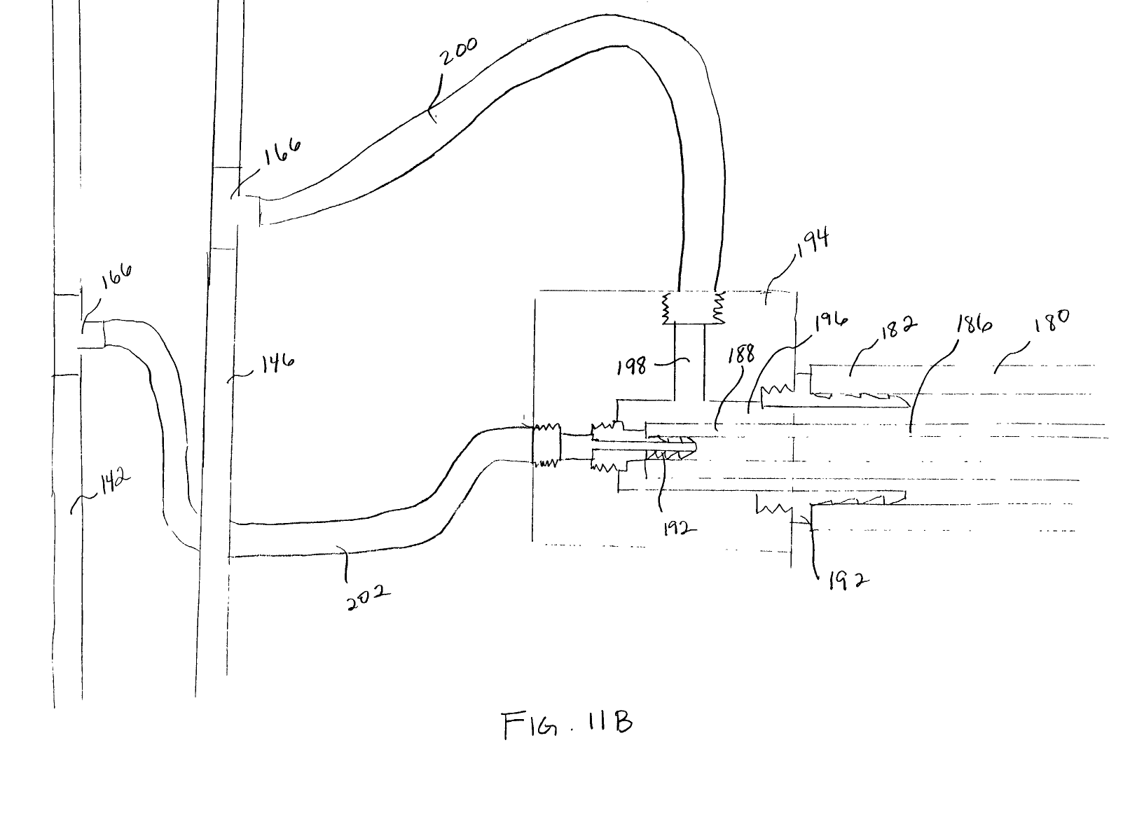

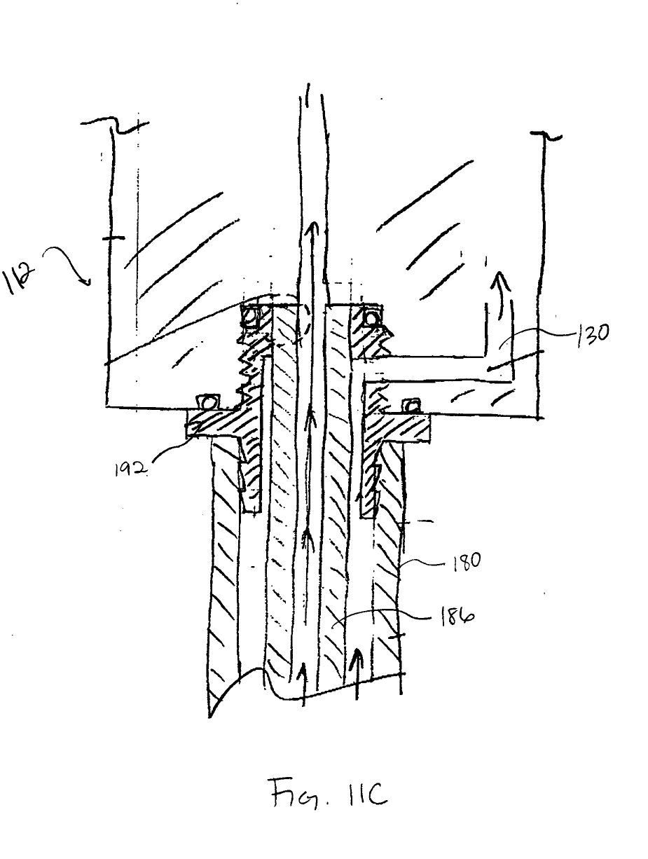

In another embodiment depicted in FIGS. 10, 11A and 11B, the spray attachment 10 may dispense hot water from the spray position 40 and cold water from the stream position 38. One skilled in the art would recognize that the stream and spray positions 38 and 40, respectively, may be designated as other positions including but not limited to hot and cold water positions. When the selector valve 36 is in the stream position 38, cold water dispenses through the stream spout 42 on the spray body 20. When the selector valve 36 is in the spray position 40, hot water dispenses through the spray spout 44 of the spray body 20. In this embodiment, the spray hose assembly 14 includes a hot water spray hose 180 having an anterior end 182 and a posterior end 184 and a cold water spray hose 186 having an anterior end 188 and a posterior end 190. One skilled in the art would recognize that the following embodiments may be utilized with any type of faucet assembly including but not limited to the embodiments depicted in FIGS. 7-9.

The spray hoses 180 and 186, respectively, may be aligned either parallel or coaxial to one another. FIG. 10 depicts hot and cold water spray hoses 180 and 186, respectively, that are aligned parallel to one another. The spray hose assembly 14 including the hot and cold water spray hoses 180 and 186 may detachably attach to the spray head 112 in the manner described above. However, the posterior end 184 of the hot water spray hose 180 bypasses the filter assembly 50 and fluidly communicates with the spray spout 44 to provide hot water to the spray spout 44 when the selector valve 36 is in the spray position 40. The anterior end 182 of the hot water spray hose 180 connects to the hot water supply line 146 with the adapter tee 166 in the manner described above in reference to FIGS. 8A, 8B, and 9. The posterior end 190 of the cold water spray hose 186 detachably attaches to the inlet 54 of the filter assembly 50 with fittings that are generally well known in the art. The filter assembly 50 communicates with the stream spout 42 to provide filtered cold water to the stream spout 42 when the selector valve 36 is in the stream position 38. The anterior end 188 of the cold water spray hose 186 connects to the cold water supply line 142 with the adapter tee 166 in the manner described above in reference to FIGS. 8A, 8B, and 9.

FIG. 11A depicts hot and cold water spray hoses 180 and 186, respectively, that are aligned coaxial to one another. In one embodiment, the hot water spray hose 180 surrounds the cold water spray hose 186. The hot water spray hose 180 detachably attaches to the proximal end 124 of the spray head 112 or to a fitting 192 which detachably attaches the hot water spray hose 180 with the opening 128 in the spray head 112. Hot water supplied to the posterior end 184 of the hot water spray hose 180 enters the cavity 126 and travels to a channel 130 which bypasses the filter assembly 50 and communicates with the spray spout 44 to provide hot water to the spray spout 44 when the selector valve 36 is in the spray position 40 (FIG. 2).

The posterior end 190 of the cold water spray hose 186 enters the spray head 112 through the opening 128 into the cavity 126 and detachably attaches to the inlet 54 of the filter assembly 50. In one embodiment, the fitting 192 couples the inlet 54 of the filter assembly 50 with the posterior end 190 of the cold water spray hose 186 to further provide a tight seal and to prevent extraction. A seal 193 abuts the filter assembly 50 to prevent leakage of hot water from the cavity 126. The outlet 56 of the filter assembly 50 fluidly communicates with the stream spout 42 to provide filtered cold water to the stream spout 42 when the selector valve 36 is in the stream position 38 (FIG. 2).

As depicted in FIG. 11B, the hot water and cold water spray hoses 180 and 186, respectively, fluidly communicate with the hot water and cold water supply lines 146 and 142, respectively, in a similar manner to FIG. 11A. The anterior end 182 of the hot water spray hose 180 detachably attaches to a manifold 194 or the fitting 192, which detachably attaches the hot water spray hose 180 with the manifold 194. Hot water supplied to the anterior end 182 of the hot water spray hose 180 enters a manifold cavity 196 and travels to a hot water channel 198. The hot water channel 198 receives a hot water tube 200 which fluidly communicates with the hot water supply line 146. In one embodiment, the hot water tube 200 fluidly communicates with the hot water supply line 146 through the use of the adapter tee 166 or other similar type fitting. The anterior end 188 of the cold water spray hose 186 enters the manifold 194 into the manifold cavity 196 and detachably attaches to a cold water tube 202 which fluidly communicates with the cold water supply line 142. In one embodiment, the fitting 192 may couple the cold water tube 202 with the anterior end 188 of the cold water spray hose 186 to further provide a tight seal and to prevent extraction. In one embodiment, the cold water tube 202 fluidly communicates with the cold water supply line 142 through the use of an adapter tee 166 or other similar type fitting.

Fittings 192 are generally well known in the art and may include but are not limited to barbs, threads, and couplers. The foregoing embodiments describe the use of at least two fittings 192 to attach the hot and cold water spray hoses 180 and 186, respectively, to the spray head 112 and at least two fittings to attach the hot water and cold water spray hoses 180 and 186, respectively, to the hot and cold water tubes 200 and 202, respectively. FIG. 11C depicts an alternate embodiment of fittings 192 utilized in the present invention wherein only one fitting 192 is need to accomplish each connection.

Referring to FIGS. 1-11C, the present invention further comprises a method for removing contaminants from water supplied to a spray attachment 10. The method may comprise attaching the filter assembly 50 to the spray head 12 or 112 or plumbing the filter assembly 100 into the water supply lines 142 or 146 or into the hose shank 154.

In attaching the filter assembly 50 to the spray head 12 or 112 as depicted in FIGS. 1-5, the user first detaches the spray head 12 or 112 from the spray hose assembly 14. Then, the filter assembly 50 is detachably attached to the spray hose assembly 14 and the spray head 12 or spray head 112, whichever is applicable. One skilled in the art would recognize that the filter assembly 50 may be attached to the spray hose assembly 14 and the spray head 12 or 112 in any order. The spray hose coupling 24 is secured to the inlet 54 of the filter assembly 50 and the outlet 56 of the filter assembly 50 is secured to the opening 21 or 128, whichever is applicable, of the spray head 12 or 112. When the spray handle 16 or 116 is depressed, water is supplied to the spray hose 30, the water flows from the spray hose 30 into the inlet 54, through the housing 52 and exits through the outlet 56 to the spray head 12 or 112 and out the nozzle 18 or 118.

In one embodiment depicted in FIG. 3A, when the water supply enters the inlet 54, the water travels through the end cap 60 which guides the water to channel 59, to the cartridge 58 and through the media 62, into the axial void 64, and exits through the outlet 56. The contaminants are removed from the water by bonding the contaminants to the media 62. Also, organisms are removed from the water by reacting the organisms in an oxidation/reduction reaction with the media 62, if applicable. In another embodiment depicted in FIG. 4, the water supply passes through the inlet 54 and inlet pad 70, if applicable, of the housing 52. Next, the water is dispersed through the chambers of media 62, and interior pads 76, if applicable, within the housing 52. The contaminants are removed from the water by bonding the contaminants to the media 62 and filters. Also, organisms are removed from the water by reacting the organisms in an oxidation/reduction reaction with the media 62, if applicable. The water supply, then, passes through the outlet pad 74 and exits through the outlet 56 of the filter assembly 50.

In a method employing the embodiment depicted in FIGS. 2, 10, and 11A-11C, the user may adjust the selector valve 36 on the spray head 12 to the spray position 40 or the stream position 38 depending on the user's preference and need for the spray attachment 10. For example, the spray position 40 may be used to rinse foods, vegetables, hands, etc., with filtered water and the stream position 38 may be utilized to fill a drinking container or when only a stream flow is desired. The spray attachment 10 depicted in FIGS. 10, 11A and 11B may be adjusted to provide hot water by adjusting the selector valve 36 to the spray position 40 and filtered cold water by adjusting the selector valve 36 to the stream position 38. When the selector valve 36 is placed in the spray position 40, hot water is supplied to the faucet assembly. The hot water is then diverted into the hot water spray hose 180 and passed into the spray head 12 where the hot water bypasses the filter assembly 50 and exits through the spray spout 44. In one embodiment, the water is passed into the cavity 126 in the spray head and directed the into the channel 130 until it reaches the spray spout 44. When the selector valve 36 is placed in the stream position 42, cold water is supplied to the faucet assembly. The cold water is then diverted into the cold water spray hose 186 and passed into the inlet 54 of the filter assembly 50. After the water has traveled through the housing 52 of the filter assembly 50, in the embodiments discussed above, the water exits the outlet 56 and is directed to the stream spout 42.

Further, the spray attachment 10 may be used in situ in the spray holder 32 or may be extended from its resting position in the spray holder 32 to supply filtered water. Valves (not shown) control the retention and release of the cold and hot water depending on the user's preference. In the resting position, filtered water may be obtained by the actuation of the spray handle 16 and positioning the container to be filled or the item to be washed under the spray head 12. In the extended position, filtered water may be obtained similarly by operation of the spray handle 16 and positioning the spray head 12 over the container or item that may be remotely located on a countertop, for instance, but within the range of the tubing supplied. The extended position also allows the user to remain more erect when using the spray attachment 10 to dispense filtered water.

Referring to FIG. 7, in another embodiment, the cold water handle 144 and/or the hot water handle 148 are placed in an “on” position to open the cold water and/or hot water supply lines 142 and 146, respectively. The water supply may then travel through the cold water and hot water supply lines 142 and 146, respectively, to the coupler tee 150. The water supply then travels from the coupler tee 150, to the hose shank 154, and through the filter assembly 100. The water supply passes through the inlet 54 and inlet pad 70, if applicable, of the housing 52. Next, the water is dispersed through the chambers of media 62, and filters, if applicable, within the housing 52. The contaminants are removed from the water by bonding the contaminants to the media 62 and filters. Also, organisms are removed from the water by reacting the organisms in an oxidation/reduction reaction with the media 62, if applicable. The water supply, then, passes through the outlet pad 74 and the outlet 56 of the filter assembly 100 into the spray hose 30. The filtered water supply is then dispensed from the spray head 12 when a user presses on the spray handle 16.

As depicted in FIGS. 8A and 9, an alternate method does not require the cold water and/or hot water supply lines 162 and 164, respectively, to be opened. The water supply travels from the cold water supply line 162 to the port 168 of the adapter tee 166. The water supply exits the adapter tee 166 through the port 172 and enters the filter assembly 100 through the inlet 54 and inlet pad 70, if applicable, of the housing 52. Next, the water is dispersed through the chambers of media 62, and filters, if applicable, within the housing 52. The contaminants are removed from the water by bonding the contaminants to the media 62 and filters. Also, organisms are removed from the water by reacting the organisms in an oxidation/reduction reaction with the media 62, if applicable. The water supply, then, passes through the outlet pad 74 and outlet 56 of the filter assembly 100 into the spray hose 30. The filtered water supply is then dispensed from the spray head 12 when a user presses on the spray handle 16.

While there has been shown and described the preferred embodiment of the instant invention it is to be appreciated that the invention may be embodied otherwise than is herein specifically shown and described and that, within said embodiment, certain changes may be made in the form and arrangement of the parts without departing from the underlying ideas or principles of this invention as set forth in the claims appended herewith.

I claim:

1. A filter assembly, comprising:
(a) a housing having an inlet and an outlet; and
(b) at least one media disposed within in the housing between the inlet and the outlet;
wherein the filter assembly is adapted to detachably attach to a spray attachment having a spray head and a spray hose assembly having at least one spray hose and a spray hose coupling.

2. The filter assembly of claim 1, wherein the inlet is configured to detachably attach to the spray hose coupling of the spray hose assembly.

3. The filter assembly of claim 1, wherein the spray attachment further comprises an opening.

4. The filter assembly of claim 3, wherein the outlet is configured to detachably attach to the opening of the spray head.

5. The filter assembly of claim 3, wherein the opening has a female end and the outlet is configured to detachably attach to the female end.

6. The filter assembly of claim 1, wherein the spray hose coupling has a male end and the inlet is configured to detachably attach to the male end.

7. The filter assembly of claim 1, wherein the inlet and outlet have threads.

8. The filter assembly of claim 7, wherein the threads comprise ¼ inch NSP threads.

9. The filter assembly of claim 1, wherein the inlet is configured to detachably attach to a hose shank in a faucet assembly.

10. The filter assembly of claim 1, wherein the inlet is configured to detachably attach to an adapter tee in a faucet assembly.

11. The filter assembly of claim 1, wherein the outlet is configured to detachably attach to the at least one spray hose.

12. The filter assembly of claim 1, wherein the housing further comprises a filter cartridge having the at least one media.

13. The filter assembly of claim 1, further comprising an end cap configured to seal the inlet.

14. The filter assembly of claim 13, wherein the end cap further comprises radial ribs configured to direct the flow of water from the inlet.

15. The filter assembly of claim 12, wherein the housing further comprises a channel extending from the inlet to the filter cartridge.

16. The filter assembly of claim 12, wherein the filter cartridge further comprises an axial void configured to fluidly communicate with the outlet

17. The filter assembly of claim 1, wherein the at least one media is selected from the group consisting of granulated activated carbon, copper, far infrared, KDF, and ATC.

18. The filter assembly of claim 1, further comprising at least one pad configured to prevent the media from traveling outside of the housing.

19. The filter assembly of claim 18, wherein the at least one pad further comprises an outlet pad configured to prevent the media from traveling through the outlet.

20. The filter assembly of claim 18, wherein the at least one pad further comprises an inlet pad configured to prevent the media from traveling through the inlet.

21. The filter assembly of claim 18, wherein the at least one pad further comprises at least one interior pad.

22. A spray head for a spray attachment, comprising a spray body having an opening, the opening configured to receive a filter assembly having a housing having an inlet and an outlet configured to engage the opening of the spray body.

23. The spray head of claim 22, wherein the spray body further comprises a female end configured to engage the outlet.

24. The spray head of claim 22, wherein the spray body further comprises a distal end, a proximal end having the opening, and a cavity extending from the proximal end to at least partially the distal end.

25. The spray head of claim 24, wherein the cavity is configured to house the filter assembly.

26. The spray head of claim 24, further comprising a spray spout and a stream spout extending from the distal end of the spray body.

27. The spray head of claim 26, wherein the spray body further comprises a channel extending from the cavity to the spray spout.

28. The spray head of claim 26, wherein the spray body further comprises a selector valve having a plurality of positions.

29. A spray attachment, comprising:
(a) a spray head comprising a spray body; and
(b) a filter assembly comprising a housing having an inlet and an outlet, the filter assembly detachably attached to the spray head.

30. The spray attachment of claim 29, wherein the spray body further comprises a female end configured to engage the outlet.

31. The spray attachment of claim 29, further comprising a spray hose assembly having a spray hose coupling and at least one spray hose, the spray hose assembly detachably attached to the filter assembly.

32. The spray attachment of claim 31, wherein the inlet of the filter assembly is configured to engage the spray hose coupling of the spray attachment.

33. The spray attachment of claim 31, wherein the spray hose coupling further comprises a male end configured to engage the inlet.

34. The spray attachment of claim 29, wherein the filter assembly further comprises at least one media extending within the housing from the inlet to the outlet.

35. The spray attachment of claim 34, wherein the media is selected from the group consisting of granulated activated carbon, copper, far infrared, KDF, and ATC.

36. The spray attachment of claim 34, wherein the filter assembly further comprises:
(i) a filter cartridge comprising the media;
(ii) an end cap configured to seal the inlet; and
(iii) a channel extending between the end cap and the filter cartridge.

37. The spray attachment of claim 34, wherein the filter assembly further comprises at least one pad configured to prevent the media from traveling outside of the housing.

38. The spray attachment of claim 29, wherein the spray head further comprises a stream spout, a spray spout, and a selector valve configured to control the flow of water out of the stream spout and the spray spout.

39. The spray attachment of claim 38, wherein the at least one spray hose comprises a hot water spray hose having an anterior end and a posterior end and a cold water spray hose having an anterior end and a posterior end.

40. The spray attachment of claim 39, wherein the posterior end of the hot water spray hose fluidly communicates with the spray spout.

41. The spray attachment of claim 39, wherein the posterior end of the cold water spray hose fluidly communicates with the filter assembly.

42. The spray attachment of claim 38, wherein the filter assembly fluidly communicates with the stream spout.

43. The spray attachment of claim 38, wherein the spray body further comprises a cavity.

44. The spray attachment of claim 43, wherein the spray body further comprises a channel extending from the cavity to the spray spout.

45. The spray attachment of claim 39, wherein the spray hose assembly further comprises a manifold configured to direct the flow of water from a hot water supply line to the anterior end of the hot water spray hose and from a cold water supply line to the anterior end of the cold water spray hose.

46. The spray attachment of claim 45, wherein the manifold further comprises a manifold cavity and a hot water channel.

47. A method of manufacturing a filtered water spray attachment, comprising,
(a) providing a spray attachment having a spray head and a spray hose assembly;
(b) providing a filter assembly having a housing having an inlet and an outlet;
(c) detachably attaching the outlet to the spray head; and
(d) detachably attaching the inlet to the spray hose assembly.

48. A combination filtered water spray attachment made by the process of:
(a) providing a spray attachment having a spray head and a spray hose assembly;
(b) providing a filter assembly comprising a housing having an inlet and an outlet;
(c) detachably attaching the outlet to the spray head; and
(d) detachably attaching the inlet to the spray hose assembly.

49. A method for filtering water supplied to a spray attachment, comprising:
(a) supplying water to a spray hose assembly;
(b) passing the water into a filter assembly comprising a housing having an inlet and an outlet and at least one media;
(c) dispersing the water through the at least one media disposed within the housing;
(d) removing contaminants from the water by bonding the contaminants to the media;
(e) passing the water out of the housing into a spray head having a nozzle; and
(f) exiting the water through the nozzle.

50. The method of claim 49, further comprising passing the water through at least one pad secured within the housing.

51. The method of claim 49, further comprising killing organisms in the water by reacting the organisms in an oxidation/reduction reaction with the media.

52. The method of claim 49, wherein passing the water into a filter assembly further comprises directing the flow of the water through radial ribs of an end cap.

53. The method of claim 52, further comprising directing the flow of the water from the radial ribs to a channel.

54. The method of claim 53, further comprising directing the flow of the water from the channel to a filter cartridge having the media.

55. The method of claim 54, wherein passing the water out of the housing further comprises directing the flow of water from an axial void in the filter cartridge to the outlet of the filter assembly.

56. A method for filtering water supplied to a spray attachment, comprising:
(a) connecting a filter assembly to a water supply;
(b) diverting the water into the filter assembly comprising a housing having an inlet and an outlet and at least one media;
(c) dispersing the water through the at least one media disposed within the housing;
(d) removing contaminants from the water by bonding the contaminants to the media;
(e) passing the water out of the housing into a spray attachment having a nozzle; and
(f) exiting the water through the nozzle.

57. The method of claim 56, further comprising passing the water through at least one pad secured within the housing.

58. The method of claim 56, further comprising eliminating organisms in the water by reacting the organisms in an oxidation/reduction reaction with the media.

59. The method of claim 56, wherein passing the water into a filter assembly further comprises directing the flow of the water through radial ribs of an end cap.

60. The method of claim 59, further comprising directing the flow of the water from the radial ribs to a channel.

61. The method of claim 60, further comprising directing the flow of the water from the channel to a filter cartridge having the media.

62. The method of claim 61, wherein passing the water out of the housing further comprises directing the flow of water from an axial void in the filter cartridge to the outlet of the filter assembly.

63. The method of claim 56, wherein connecting the filter assembly to the faucet assembly further comprises connecting the filter assembly to a coupler tee on the faucet assembly.

64. The method of claim 56, wherein connecting the filter assembly to the faucet assembly further comprises connecting an adapter tee to a water supply line of the faucet assembly.

65. The method of claim 64, further comprising connecting the filter assembly to the adapter tee.

66. A method of manufacturing a spray attachment, comprising:
(a) connecting a hot water spray hose to a hot water supply line;
(b) connecting a cold water spray hose to a cold water supply line;
(c) detachably attaching a filter assembly to a spray head;
(d) detachably attaching the hot water spray hose to the spray head;
(e) detachably attaching the cold water spray hose to the filter assembly; and
(f) providing a selector valve having a plurality of positions.

67. The method of claim 66, further comprising aligning the hot water spray hose parallel to the cold water spray hose.

68. The method of claim 67, wherein detachably attaching the hot water spray hose to the spray head further comprises bypassing the filter assembly.

69. The method of claim 68, further comprising attaching the hot water spray hose to a spray spout.

70. The method of claim 66, further comprising aligning the hot water spray hose coaxial to the cold water spray hose.

71. The method of claim 70, further comprising providing a cavity in the spray head.

72. The method of claim 71, further comprising providing a channel in the spray head extending from the cavity to the spray spout.

73. The method of claim 70, wherein connecting the hot water spray hose to the hot water supply line and connecting the cold water spray hose to the cold water supply line further comprises connecting the hot water spray hose, the cold water spray hose, the hot water supply line, and the cold water supply line to a manifold.

74. A method of supplying unfiltered water to a spray attachment having a filter assembly, comprising:
(a) positioning a selector valve to an unfiltered position;
(b) supplying water to a faucet assembly;
(c) diverting the water into a spray hose assembly;
(d) passing the water into a spray head;
(e) bypassing the filter assembly;
(f) passing the water to an unfiltered spout; and
(g) exiting the water through the unfiltered spout.

75. The method of claim 74, wherein passing the water into the spray head further comprises passing the water into a cavity in the spray head.

76. The method of claim 75, further comprising directing the water from the cavity into a channel.

77. Filtered water made by the process of:
(a) supplying water to a spray hose assembly;
(b) passing the water into a filter assembly;
(c) passing the water out of the filter assembly into a spray head having a nozzle; and
(f) exiting the water through the nozzle.

78. Filtered water made by the process of claim 77, further comprising dispersing the water through at least one media disposed within the filter assembly.

79. Filtered water made by the process of claim 78, further comprising removing contaminants from the water by bonding the contaminants to the at least one media.

80. Filtered water made by the process of:
(a) connecting a filter assembly to a faucet assembly;
(b) supplying water to the faucet assembly;
(c) diverting the water into the filter assembly;
(d) passing the water out of the filter assembly into a spray attachment having a nozzle; and
(e) exiting the water through the nozzle.

81. Filtered water made by the process of claim 80, further comprising dispersing the water through at least one media disposed within the filter assembly.

82. Filtered water made by the process of claim 81, further comprising removing contaminants from the water by bonding the contaminants to the at least one media.
